(19) United States
(12) Patent Application Publication
(10) Pub. No.: US 2011/0261499 A1
(43) Pub. Date: Oct. 27, 2011

(54) COLLECTOR ELECTRODE FOR AN ION WIND FAN

(75) Inventors: Christopher HIZER, Campbell, CA (US); Brian D. Sawyer, Palol Alto, CA (US)

(73) Assignee: Ventiva, Inc., Santa Clara, CA (US)

(21) Appl. No.: 12/767,697

(22) Filed: Apr. 26, 2010

(51) Int. Cl. H01T 23/00

(52) U.S. Cl. 361/231

(57) ABSTRACT

An ion wind fan can have a collector electrode that mitigates the risk of sparking. In one embodiment, an ion wind can include a wire emitter electrode held in tension in a first direction, and a collector electrode having an elongated opening having an upstream edge and a downstream edge, the elongated opening being elongated in the first direction and positioned downstream of the wire emitter electrode so that the wire emitter electrode is substantially centered along the length of the elongated opening. The downstream edge of the elongated opening includes a chamfered portion.

### FIELD OF THE INVENTION

The embodiments of the present invention are related to ion wind fans, and in particular to a collector electrode for an ion wind fan.

### BACKGROUND

It is well known that heat can be a problem in many electronics device environments, and that overheating can lead to failure of components such as integrated circuits (e.g. a central processing unit (CPU) of a computer) and other electronic components. Most electronics devices, from LED lighting to computers and entertainment devices, implements some form of thermal management to remove excess heat.

Heat sinks are a common passive tool used for thermal management. Heat sinks use conduction and convection to dissipate heat and thermally manage the heat-producing component. To increase the heat dissipation of a heat sink, a conventional rotary fan or blower fan has been used to move air across the surface of the heat sink, referred to generally as forced convection. Conventional fans have many disadvantages when used in consumer electronics products, such as noise, weight, size, and reliability caused by the failure of moving parts and bearings.

A solid-state fan using ionic wind to move air addresses the disadvantages of conventional fans. However, providing an ion wind fan that meets the requirements of consumer electronics devices presents numerous challenges not addressed by any currently existing ionic wind device. One such challenge faced by currently existing ion wind devices is sparking across electrodes and dust accumulation. Sparks can damage electrodes and other electronic components, create a sharp audible noise, and can create electromagnetic interference (EMI). Dust can change the electrostatics of an ion wind fan resulting in degraded performance.

### BRIEF DESCRIPTION OF THE DRAWINGS

FIG. 1 is a block diagram illustrating an ion wind fan implemented as part of thermal management of an electronic device;

FIG. 2A is a perspective view of an ion wind fan;

FIG. 2B is a widthwise cross-sectional view of the ion wind fan of FIG. 2A;

FIG. 3A is a cross-sectional view of a prior art electrostatic precipitator;

FIG. 3B is a cross-sectional view of a prior art electrostatic precipitator;

FIG. 3C is a cross-sectional view of a prior art electrostatic precipitator;

FIGS. 4A(1) and (2) is a simplified cross-sectional view of an ion wind fan according to one embodiment of the present invention;

FIG. 4B is a simplified cross-sectional view of an ion wind fan according to another embodiment of the present invention;

FIG. 4C is a simplified cross-sectional view of an ion wind fan according to yet another embodiment of the present invention;

FIG. 5A is a simplified cross-sectional view of an ion wind fan according to yet another embodiment of the present invention;

FIG. 5B is a cross-sectional perspective view of an ion wind fan according to the embodiment of the present invention shown in FIG. 5A;

FIG. 5C is a perspective downstream view of a collector electrode for an ion wind fan according to one embodiment of the present invention;

FIG. 5D is a perspective upstream view of a collector electrode for an ion wind fan according to one embodiment of the present invention;

FIG. 5E is a cross-sectional perspective view of an ion wind fan according to the embodiment of the present invention shown in FIG. 5C;

FIG. 6A is a perspective downstream view of a collector electrode for an ion wind fan according to another embodiment of the present invention; and

FIG. 6B is a cross-sectional view of the collector electrode for an ion wind fan according to the embodiment of the present invention shown in FIG. 6A.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode, getter electrode, or collector electrode.

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. The concept of ion wind has been implemented in relatively large-scale air filtration devices, such as the Sharper Image Ionic Breeze.

### Example Ion Wind Fan Thermal Management Solution

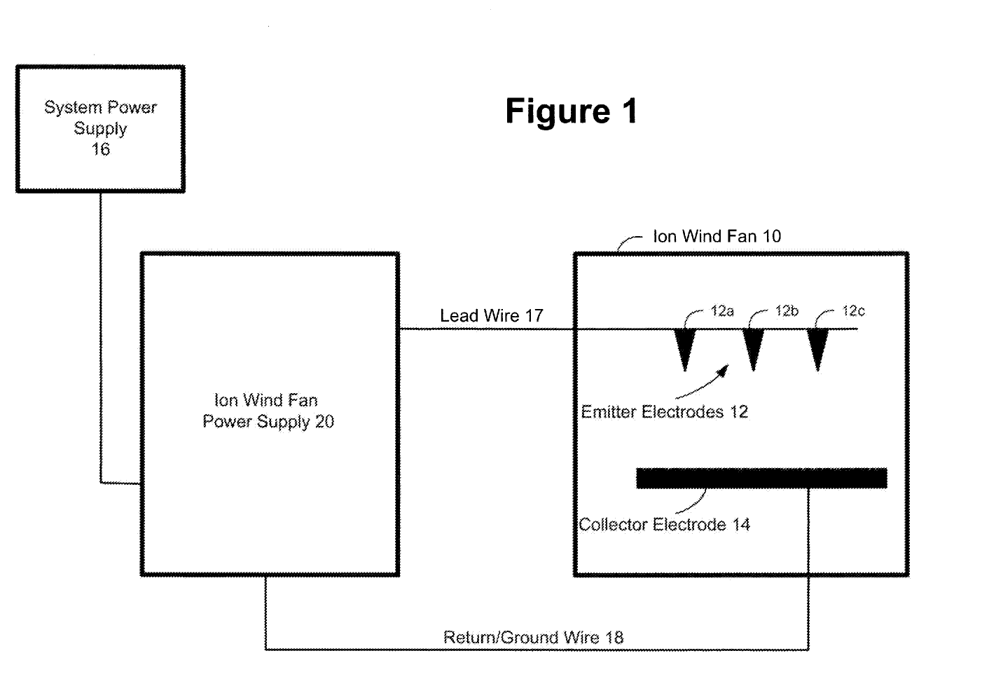

FIG. 1 illustrates an ion wind fan 10 used as part of a thermal management solution for an electronic device. As used in this Application, the descriptive term “ion wind fan,” is used to refer to any electro-aerodynamic pump, electro-hydrodynamic (EHD) pump, EHD thruster, corona wind device, ionic wind device, or any other such device used to move air or other gas. The term “fan” refers to any device that move air or some other gas. The term ion wind fan is meant to distinguish the fan from conventional rotary and blower fans. However, any type of ionic gas movement can be used in an ion wind fan, including, but not limited to corona discharge, dielectric barrier discharge, or any other ion generating technique.

An electronic device may need thermal management for an integrated circuit—such as a chip or a processor—that produces heat, or some other heat source, such as a light emitting diode (LED). Some example systems that can use an ion wind fan for thermal management include computers, laptops, gaming devices, projectors, television sets, set-top boxes, servers, NAS devices, memory devices, LED lighting devices, LED display devices, smart-phones, music players and other mobile devices, and generally any device having a heat source requiring thermal management.

The electronic device can have a system power supply 16 or can receive power directly from the mains AC via a wall outlet, Edison socket, or other outlet type. For example, in the case of a laptop computer, the laptop will have a system power supply such as a battery that provides electric power to the electronic components of the laptop. In the case of a wall-plug device such as a gaming device, television set, or LED lighting solution (lamp or bulb), the system power supply 16 will receive the 110V mains AC (in the U.S.A, 220V in the EU) current from an electrical outlet or socket.

The system power supply 16 for such a plug or screw-in device will also convert the mains AC into the appropriate voltage and type of current needed by the device (e.g., 20-50V DC for an LED lamp). While the system power supply 16 is shown as separate from the IWFPS 20, in some embodiments, one power supply can provide the appropriate voltage to both an ion wind fan 10 and other components of the electronic device. For example, a single driver can be design to drive the LEDs of and LED lamp and an ion wind fan included in the LED lamp.

The electronic device also includes a heat source (not shown), and may also include a passive thermal management element, such as a heat sink (also not shown). To assist in heat transfer, an ion wind fan 10 is provided in the system to help move air across the surface of the heat source or the heat sink, or just to generally circulate air (or some other gas) inside the device. In prior art systems, conventional rotary fans with rotating fan blades have been used for this purpose.

As discussed above, the ion wind fan 10 operates by creating a high electric field around one or more emitter electrodes 12 resulting in the generation of ions, which are then attracted to a collector electrode 14. In FIG. 1, the emitter electrodes 12 are represented as triangles as an illustration that they are generally “sharp” electrodes. However, in a real-world ion wind fan 10, the emitter electrodes 12 can be implemented as wires, shims, blades, pins, and numerous other geometries. Furthermore, while the ion wind fan 10 in FIG. 1 has three emitter electrodes (12a, 12b, 12c), the various embodiments of the present invention described herein can be implemented in conjunction with ion wind fans having any number of emitter electrodes 12.

Similarly, the collector electrode 14 is shown simply as a plate in FIG. 1. However, a real-world collector electrode 14 can have various shapes and will generally include openings to allow the passage of air. The collector electrode 14 can also be implemented as multiple collector electrode members (e.g., rods, washers) held at substantially the same potential. Furthermore, in a real world ion wind fan 10, the emitter electrodes 12 and the collector electrode 14 would be disposed on a dielectric chassis—sometimes referred to as an isolator element—that has also been omitted from FIG. 1 for simplicity and ease of understanding.

To create the high electric field necessary for ion generation, the ion wind fan 10 is connected to an ion wind power supply 20. The ion wind power supply 20 is a high-voltage power supply that can apply a high voltage potential across the emitter electrodes 12 and the collector electrode 14. The ion wind fan power supply 20 (hereinafter sometimes referred to as “IWFPS”) is electrically coupled to and receives electrical power from the system power supply 16. Usually for electronic devices, the system power supply 16 provides low-voltage direct current (DC) power. For example, a laptop computer system power supply would likely output approximately 5-12V DC, while the power supply for an LED light fixture would likely output approximately 20-70V DC.

The high voltage DC generated by the IWFPS 20 is then electrically coupled to the emitter electrodes 12 of the ion wind fan 10 via a lead wire 17. The collector electrode 14 is connected back to the IWFPS 20 via return/ground wire 18, to ground the collector electrode 14 thereby creating a high voltage potential across the emitters 12 and the collector 14 electrodes. The return wire 18 can be connected to a system, local, or absolute high-voltage ground using conventional techniques.

While the system shown in and described with reference to FIG. 1 uses a positive DC voltage to generate ions, ion wind can be created using AC voltage, or by connecting the emitters 12 to the negative terminal of the IWFPS 20 resulting in a “negative” corona wind. Embodiments of the present invention are not limited to positive DC voltage ion wind. Furthermore, while the IWFPS 20 is shown to receive power from a system power supply 30, in other embodiment, the IWFPS 20 can receive power directly from an outlet.

The IWFPS 20 may include other components. Furthermore, in some embodiments, some of the components listed above may be omitted or replaced by similar or equivalent circuits. For example, the IWFPS 20 is described only as an example. Many different kinds and types of power supplies can be used as the IWFPS 20, including power supplies that do not have a transformers or other components shown in FIG. 1. The components described need not be physically separate, and may be combined on a single printed circuit board (PCB).

### Collector Electrodes

As described partially above, ion wind is generated by the ion wind fan 10 by applying a high voltage potential across the emitter 12 and collector 14 electrodes. This creates a strong electric field around the emitter electrodes 12, strong enough to ionize the air in the vicinity of the emitter electrodes 12, in effect creating a plasma region. The ions are attracted to collector electrode 12, and as they move in air gap along the electric field lines, the ions bump into neutral air molecules, creating airflow. On a real world collector electrode 14, air passage openings (not shown) allow the airflow to pass through the collector 14 thus creating an ion wind fan.

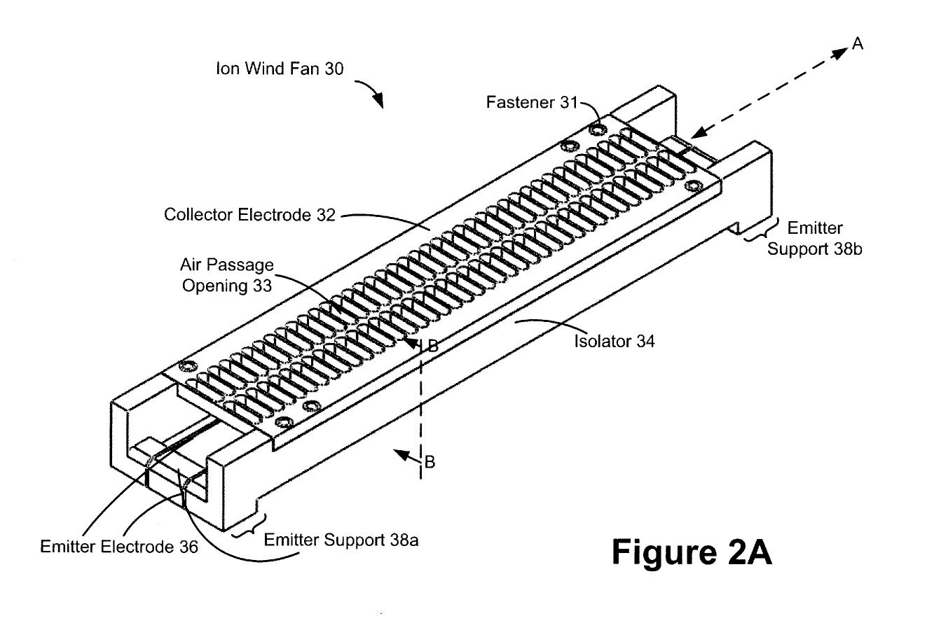

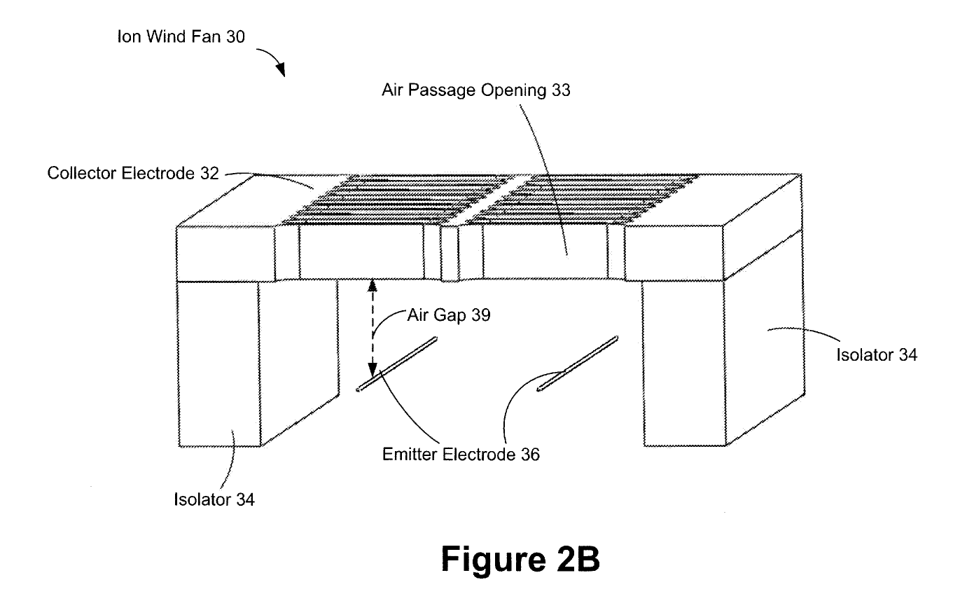

An example of such an ion wind fan is now described with reference to FIGS. 2A and 2B. FIG. 2A is a perspective view of an example ion wind fan 30. The ion wind fan 30 includes a collector electrode 32 having air passage openings 33 to allow airflow. This example ion wind fan 30 has two emitter electrodes 36 implemented as wires, thus implementing what is sometimes referred to as a “wire-to-plane” configuration.

The collector electrode 32 and the emitter electrodes 36 are both supported by an isolator 34. The isolator is made of a dielectric material, such as plastic, ceramic, and the like. The “isolator” component is thusly named as it functions to electrically isolate the emitter electrodes 36 from the collector electrode 32, and to physically support these electrodes. As such the isolator also can establish the spatial relationship between the electrodes, sometimes referred to under the rubric of electrode geometry. The isolator 34 can be made from one integral piece—as shown in FIG. 2A—or it can be made of multiple parts and pieces.

In the embodiment shown in FIG. 2A, the collector electrode is attached to the isolator using a fastener 31. The fastener 31 in FIG. 2 is a stake, but any other attachment method can be used, including but not limited to screws, hooks, glue, and so on. Similarly, the particular method of attachment of the emitter electrodes 36 is not essential to the embodiments of the present invention. The emitter electrodes 36 can be glued, staked, screwed, tied, held by friction, or attached in any other way to the isolator 34.

The ion wind fan 30—in the embodiment shown in FIG. 2A—is substantially rectangular in top view. The longitudinal axis of the ion wind fan 30 is denoted with the dotted arrow labeled “A.” The ion wind fan 30 has two ends opposite each other along the longitudinal axis. The emitter electrodes 36 are suspended between the two ends of the ion wind fan 30.

In one embodiment, the emitter electrodes 36 are supported at the ends of the ion wind fan 30 by an emitter support 38 portion of the isolator 34. The emitter support 38a at the left end of the ion wind fan 30 is most visible in FIG. 2A. The emitter support 38a is a portion of the isolator that physically supports the emitter electrodes 36. In one embodiment, the emitter electrodes 36 are suspended (in tension) between the two emitter supports 38 at the two ends of the ion wind fan 30.

In the embodiment shown in FIG. 2A, the isolator 34 has two elongated members oriented along the longitudinal direction that support the collector electrode 32, and the two elongated members are held joined by two cross-members that support the emitter electrodes 36. In one embodiment, these cross-members are oriented perpendicular to the elongated members (and thus the longitudinal axis). In FIG. 2A, these cross-members make up the emitter supports 38.

Thus, while in one embodiment the emitter support 38a is a substantially rectangular solid portion of the isolator 34 that connects the two elongated side portions of the isolator 34, in other embodiments the emitter supports 38 can have many other shapes and orientations. For example, a part of the center portion of the emitter support 38a between the emitter electrodes 36 could be cut away without substantially affecting the function of the emitter support 38a.

The emitter support 38a is shown as extending to the end of the ion wind fan 30. However, in other embodiments, the emitter support 38a can end before the end of the ion wind fan 30. The emitter support 38a is also shown as having a curved section at its outside edge to smooth out the 90 degree bend in the wire emitter electrodes 36. This is an optional feature not related to the embodiments of the present invention described herein.

Indeed, the actual attachment of the emitter electrodes 36 to either the emitter support 38 or some other portion of the isolator 34 is not material to the embodiments of the present invention, and therefore will not be discussed in much detail for simplicity and ease of understanding. The emitter electrodes 36 are shown as extending downward from the left end of the ion wind fan 30 and they are connected to the power supply via some wire or bus, as is the collector electrode 32. The emitter supports 38 need not have any particular shape of contact with the emitter electrodes 36. The emitter supports 38 are the portions of the isolator 34 that define the physical spatial relationship between the emitter electrodes 34 and other components of the ion wind fan 30. How exactly the emitter supports 38 are in contact with the emitter electrodes 36 (grooves, stakes, friction, posts, welding, epoxy) are not germane to the embodiments of the present invention.

FIG. 2B further illustrates the example ion wind fan 30 shown in FIG. 2A. FIG. 2B is a perspective cross sectional view of the ion wind fan 30 along the line B-B shown in FIG. 2A. The emitter electrodes 36 are suspended in air, and held a substantially constant air gap 39 distance away from the collector electrode 32.

Though wire sag and other emitter irregularities will create some variance, in one embodiment the air gap 39 between the emitter electrodes 36 and the bottom plane of the collector electrode 32 is substantially constant (within a 5% variation). In other embodiments, the air gap 39 can be more variable. The size of the air gap 39 is dependent on the spatial relationship between the electrodes established by the emitter supports 38 (which are not visible in FIG. 2B).

While the collector electrode 32 shown in FIGS. 2A-B works well, it does have a few drawbacks. The collector electrode 32 is essentially a plate with rows of oval holes lined up along the length of each emitter electrode 36. This results in a non-uniform electric field along the length of the emitter electrode 36, since some portions above the wire 36 have an air passage opening 33 and some have the portions between the openings 33. Some prior art collector electrode configurations have uniform electric fields along the length of emitter electrodes, but each of these prior art solutions have other drawbacks.

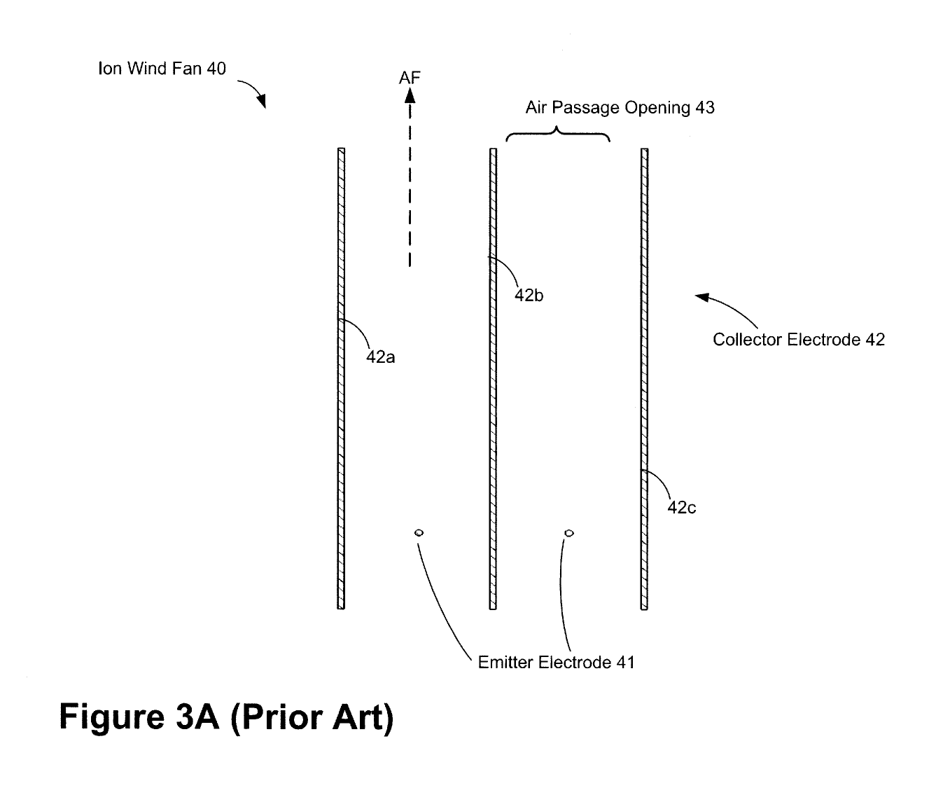

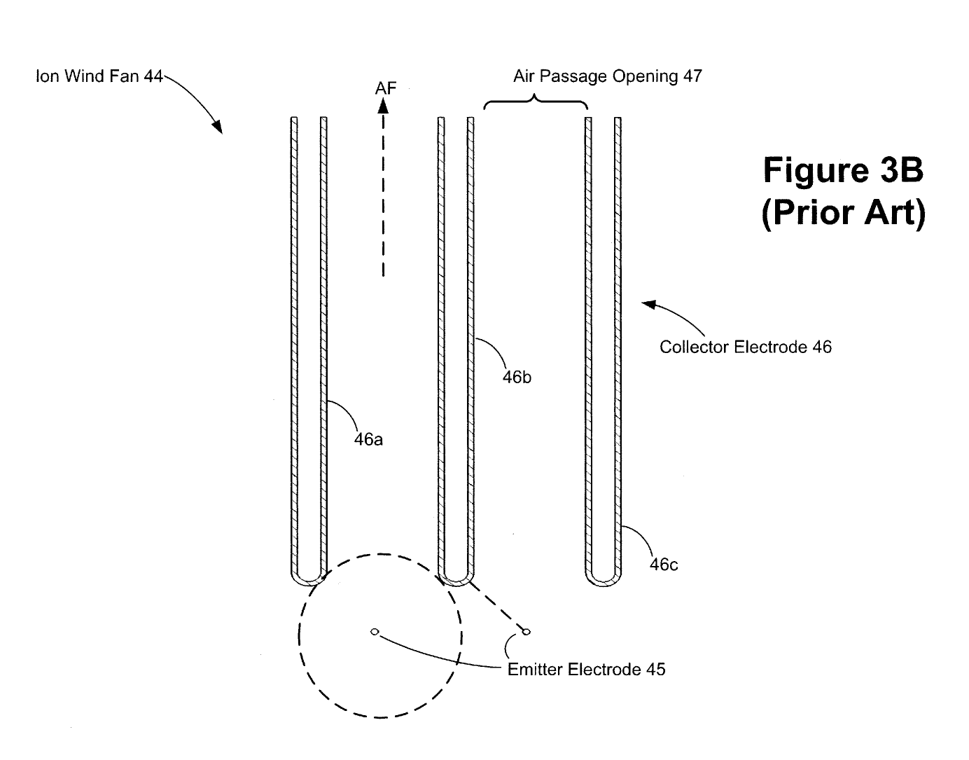

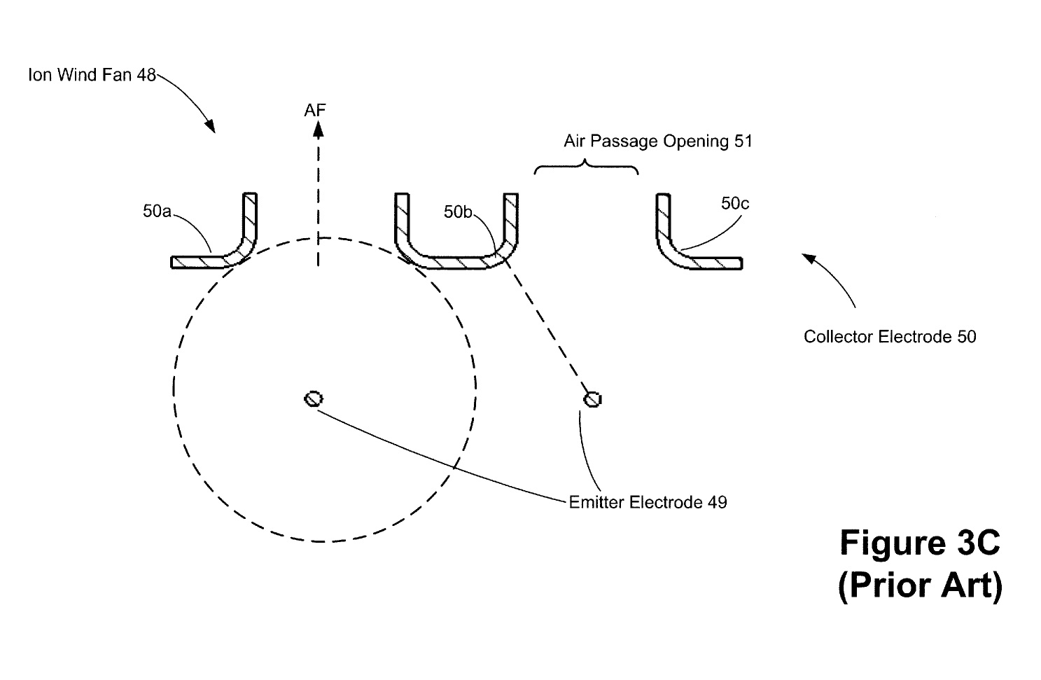

For example, FIG. 3A shows an ion wind fan 40 having a collector electrode 42 made up of three parallel plates. An emitter electrode 41 is positioned in the middle of the channel ending in an air passage opening 43 defined by two plates (e.g., plate 42b and plate 42c). The desired direction of airflow is indicated by the dashed arrow labeled “AF.” Such an ion wind fan 40 is shown, for example, in FIG. 7 of U.S. Pat. No. 6,919,698 to Krichtafovitch, dated Jul. 19, 2005, titled “Electrostatic Fluid Accelerator for and Method of Controlling a Fluid Flow,” (the '698 patent) although that example uses a blade emitter electrode instead of a wire emitter electrode.

While the ion wind fan 40 shown in FIG. 3A does have a uniform electric field at the collector electrode 42 along the length of the emitter electrodes 41, the placement of the emitter electrodes 41 inside the channel would result in ion directionality that is not very efficient for optimum airflow generation. For example, many ions generated by the ion wind fan 40 will initially traverse perpendicular to the intended direction of airflow (AF) and even more then 90 degrees from the AF axis. Such as embodiment can work for electrostatic precipitators, where air movement is not the primary objective, but for an ion wind fan, such a configuration is not efficient.

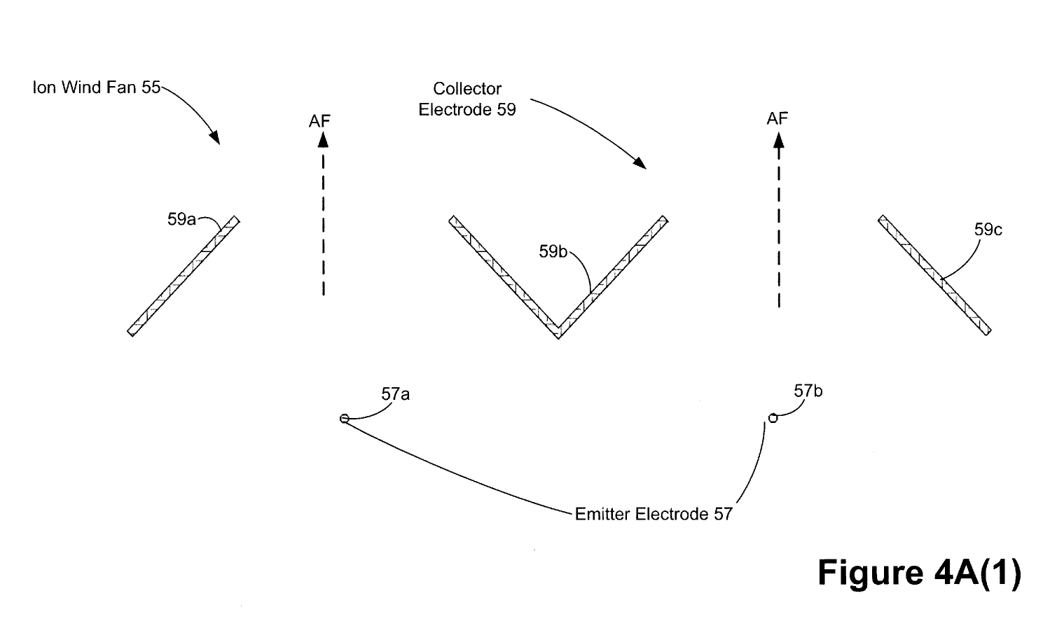

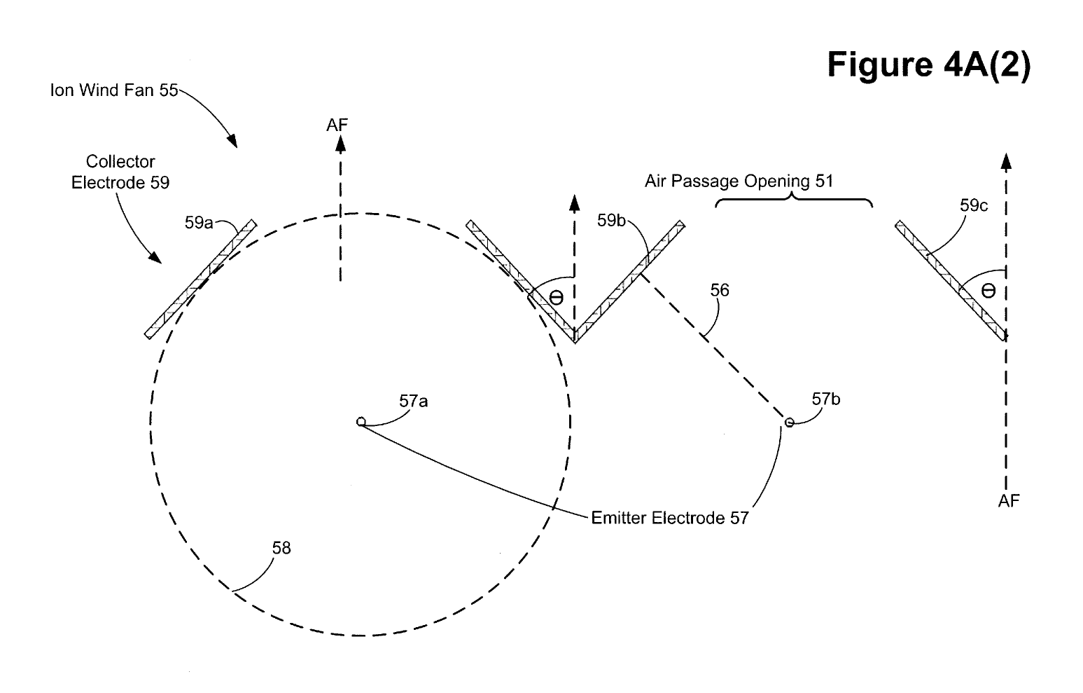

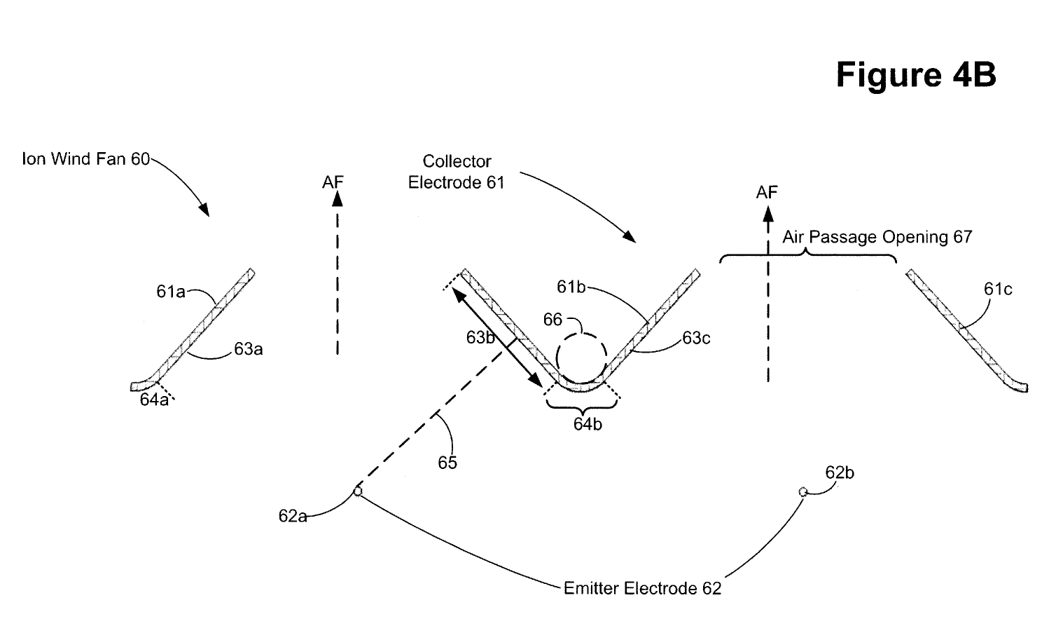

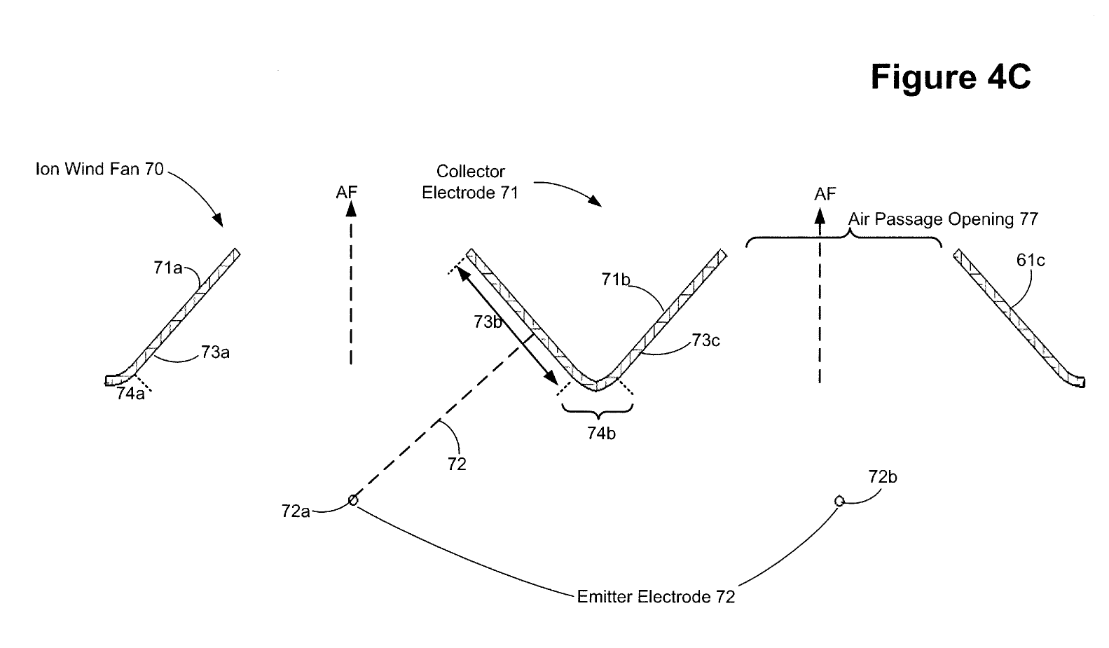

Another ion wind fan 44 having elongated U-shaped members 42a-c for the collector electrode 42 is shown in FIG. 3B. Such an ion wind fan is also shown, for example, as FIG. 4B of U.S. Pat. No. 6,713,026 to Taylor, et al., dated Mar. 30, 2004, titled “Electro-kinetic Air Transporter-Conditioner,” (the '026 patent), and substantially similar ion wind fans are shown as FIG. 1 of the '698 patent. The collector electrode 46 of ion wind fan 44 has three U-shaped members 42a-c. These members extend into the page along the length of the emitter electrodes 45. As such, each member is basically a metallic sheet folded into a U-shape.

The space between the members 46a-c forms both the air passage channel and the air passage opening 47 at the end of the channels. The direction of airflow (AF) is again substantially parallel to the orientation of the collector members 46a-c. While ion directionality is improved by the design in FIG. 3B over the design in FIG. 3A, the “near-point” from the emitter electrodes 45 to the collector electrode 46 is now at a convex-curved surface.

The dotted circle centered around the left-side emitter electrode 45 illustrates that the surface of the members 46a and 46b closest to the emitter electrode is the curved portion of the U-shape. The dotted line extending from the right-side emitter electrode 45 illustrates the same point. For the large-scale electrostatic precipitator applications contemplated in the '026 and '698 patents that have air gaps in the centimeter range, the location of the “near-point” on such a curved surface is not important. But by working with ion wind fans on a much smaller scale—fans having air gaps of just a few millimeters—the inventors of the present application discovered that having the nearest surface of the collector electrode to an emitter electrode by a convex curve resulted in increased likelihood of sparking between the electrodes. The sharper the curvature of surface of the collector nearest the emitter, the more pronounced the sparking that has been observed.

The ion wind fan 48 shown in FIG. 3C is similar to the ion wind fan 44 shown in FIG. 3B, except with shorter air channels and side-members 50a and 50c having an L-shape instead of a U-shape. Such an ion wind fan is described with reference to and shown as FIG. 4D of the '026 patent. For small-scale ion wind fans, the collector design shown in FIG. 3C suffers from the same disadvantages as the design shown in FIG. 3B. As illustrated by the dotted circle and “short path” distance dotted line, the area of the collector that is nearest the emitter electrodes is a curved area, resulting in a higher electrical field concentration and higher sparking potential.

In the discussion of collector electrodes above, and also in the descriptions below, a collector electrode will be referred to in the singular, even when made up of multiple members that may not touch each other or be composed of a monolithic or integral structure. As long as the members are used to accelerate/collect ions (or electrons in the case of negative corona applications) and are held at the same potential—usually ground or the negative terminal of the power supply—the collection of members (such as members 50a, 50b, and 50c in FIG. 3C) will be referred to as one collector electrode.

### Slanted Surface Collector Electrode

One embodiment of the present invention is now described with reference to FIGS. 4A(1) and 4A(2). FIG. 4A(1) is a simplified cross-sectional view of an ion wind fan 55. This cross-section is roughly the equivalent of the cross-section taken along the line B-B in FIG. 2A. In other words, the view is sighting down in the longitudinal direction. The isolator is not shown for simplicity and ease of understanding. The desired direction of airflow is once again indicated by arrows AF.

The ion wind fan 55 has a collector electrode 59 having three elongated members 59a-c. Elongated member 59a is substantially a plane surface elongated in the longitudinal direction and slanted about 45 degrees to the right from the direction of desired airflow AF. Similarly, elongated member elongated member 59c is substantially a plane surface elongated in the longitudinal direction and slanted about 45 degrees to the left from the direction of desired airflow AF. In the middle, elongated member 59b is substantially a V-shaped intersection of two planes elongated in the longitudinal direction.

As can be seen in FIG. 4A(1), this collector 59 arrangement creates two elongated openings; one opening between member 59a and the left side of member 59b, and another opening between the right side of member 59b and member 59c. As such, ion wind fan 55 can be said to be a two-channel fan. More channels can be added by inserting more V-shaped members (such as member 59b) and additional emitter electrodes 57.

The emitter electrodes of the ion wind fan 55 are wire emitters held in tension in the longitudinal direction, similar to the emitter wires 36 shown in FIG. 2A. They appear as circles as they have a round cross-section, although other cross-sectional wires can be used, in addition to other types of emitter types and geometries.

The emitter electrodes 57 and the collector electrode 59 have a spatial relation, such that the emitter electrodes are substantially centered between two members of the collector electrode 59 on the upstream side of the collector electrode 59. For example, the left emitter electrode 57a is approximately centered between members 59a and 59b.

FIG. 4A(2) shows the same ion wind fan 55 as FIG. 4A(2), with additional labels and explanations. For example, the dotted circle 58 around the left emitter electrode 57 shows the near-points on members 59a and 59b to the emitter electrode 57a. It should be appreciated, that the “near-point” is actually a line along the surface of the collector electrode member extending in the longitudinal direction and parallel to the emitter electrode 57. However, in cross-section, the term near-point indicates the area of a collector member that is closest to the emitter electrode 57.

As shown by dotted circle 58 that is centered around emitter electrode 57a and by dotted line 56 that extends from emitter electrode 57b and perpendicular to member 59b, the near-point is located—in this embodiment—approximately mid-way along the collector electrode members 59 in the direction of airflow. The distance from the emitter electrodes 57 to the collector electrode 59—which is the length of the dotted line 56 and the radius of the dotted circle 58—is the air gap analogous to the air gap 39 shown in FIG. 2B.

In FIG. 4A(2), the angle θ represents the angle of the slant of the surface of the collector electrode members 59 from the axis of airflow. In the embodiment shown in FIG. 4A, this angle is approximately 45 degrees. However, in other embodiments, the slant can vary between 25-75 degrees. The air gap 56 can be varied by changing the angle θ or by moving the collector electrode 59 up/down along the airflow axis AF with respect to the emitter electrodes 57.

The electrode arrangement shown in FIG. 4A has several advantages over the prior art arrangements shown in FIGS. 3A-C, as well as over the flat-plate type collector shown in FIG. 2A. Unlike the collector electrode 32 in FIG. 2A, the collector electrode 59 has a uniform electrical field along the length of the emitter electrodes 57. The air passage openings 51 extend for the length of the active portions of the emitter electrodes 57.

Furthermore, unlike the collector electrodes shown in FIGS. 3A-C, the near-point or near-surface of the collector electrode 59 is along a flat or substantially flat surface that is in front of the emitter electrodes in an upstream direction. The collector electrode 59 of FIG. 4A thus accelerates ions in the desired direction of airflow better than the collector electrodes shown in FIGS. 3A-C, and at the same time, is less prone to sparking between electrodes.

However, the collector electrode 59 and the ion wind fan 55 do have a disadvantage. The sharp point at the center of elongated member 59b at the junction of the right and left plates can potentially concentrate the electrical field and become a spark point for the emitter electrodes 57. To address this issue, the collector electrode 61 of ion wind fan 60 shown in FIG. 4B has rounded tip section 64.

FIG. 4B again shows one embodiment of the ion wind fan 60 in cross-section taken along the B-B line, and omits the isolator for simplicity and ease of understanding. The actual physical relationship of the emitter 62 and collector electrodes 61 is determined by their attachment to the isolator.

In the embodiment shown in FIG. 4B, the side-members (61a, 61c) have a slanted planar portion 63a and a rounded portion 64a. The rounded portions 64a arc away from the nearest emitter electrode 62. In one embodiment, the curve of the rounded portion 64a is tangential to the planar portion 63a, so that the transition from planar to rounded portion is smooth, with no sharp edges.

The center-member 61b has two rounded planar portions (63b, 63c) connected by a rounded portion 64b. The dotted circle 66 illustrates that the rounded portion 64b has a single radius, the length of the radius being the radius of the dotted circle 66. In one embodiment, the curve of the rounded portion 64b is tangential to the both planar portions 63b and 63c, so that the transition from planar to rounded portion is smooth, with no sharp edges. In such an embodiment, the length of the radius is determined by the angle between the planar portions 63b and 63c—which is approximately 90 degrees in FIG. 4B—and by the relative size of the ion wind fan 60.

In one embodiment, the spatial relationship of the emitter electrodes 62 to the collector electrode 61 is such that the planar portions 63 of the collector electrode 61 are nearest to the emitter electrodes 62. For example, dotted line 65 illustrates that the “near-point” from emitter electrode 62a to central-member 61b is along the slanted planar portion 63b. The electrical field will be lower along the planar portion 63b than along the rounded portion 64b. Thus, having the slanted planar portion 63b be nearest the emitter electrode 62a can produce an ion wind fan 60 that is less prone to sparking across the electrodes.

The width of the air passage opening 67—i.e., the distance between the elongated members 61—is dependant on various geometry considerations, such as the air gap 65 and the length of the planar portions 63. However, the with of the air passage openings 67 must be consistent with the design objective of having the “near-point” on the collector electrode 61 to the emitter electrodes 62 be along the planar portions 63 of the collector electrode. For example, if the elongated members are moved too close together, the curved portions 64 will be nearer to the emitter electrodes 62 than the planar portions 63. This sizing requirement applies to all embodiments of the present invention discussed herein, and not only to the embodiment shown in FIG. 4B.

Another embodiment of the present invention is now described with reference to FIG. 4C. The ion wind fan 70 of FIG. 4C differs from the embodiment shown in FIG. 4B in that the rounded portion 74b at the tip of the center-member 71b has a double-radius, instead of a single radius. The length of the radii of the two arcs that together make up the rounded portion 74b are equal, but not centered at the same location.

In one embodiment, each arc is still tangent to its adjacent planar portion (73b and 73c respectively). In such an embodiment, the tip/middle of the rounded portion 74b will have a sharp feature or edge, as is visible in FIG. 4C. While such a sharp edge will focus the electrical field more than the completely rounded portion 64b of FIG. 4B, it will still focus the electrical field less than the angular tip/center portion at the junction of the two plates of member 59b in FIG. 4A. One reason for using a double-radius rounded section—verses a single-radius rounded section—is that the double-radius rounded section 74b may be less prone to accumulate dust or other contamination than a single-radius rounded section 64b.

As in the embodiment shown in FIG. 4B, for the ion wind fan 70 of FIG. 4C, the emitter electrodes 62 are still nearest the collector electrode 71 at the planar portions 73 of the elongated members 71. This is again illustrated by the dotted line 72 showing the shortest distance from the left emitter electrode 72a to the center-member 71b. Thus, the dotted line 72 extends from the emitter electrode 72a and intersects the surface of the planar portion 73b at a right angle.

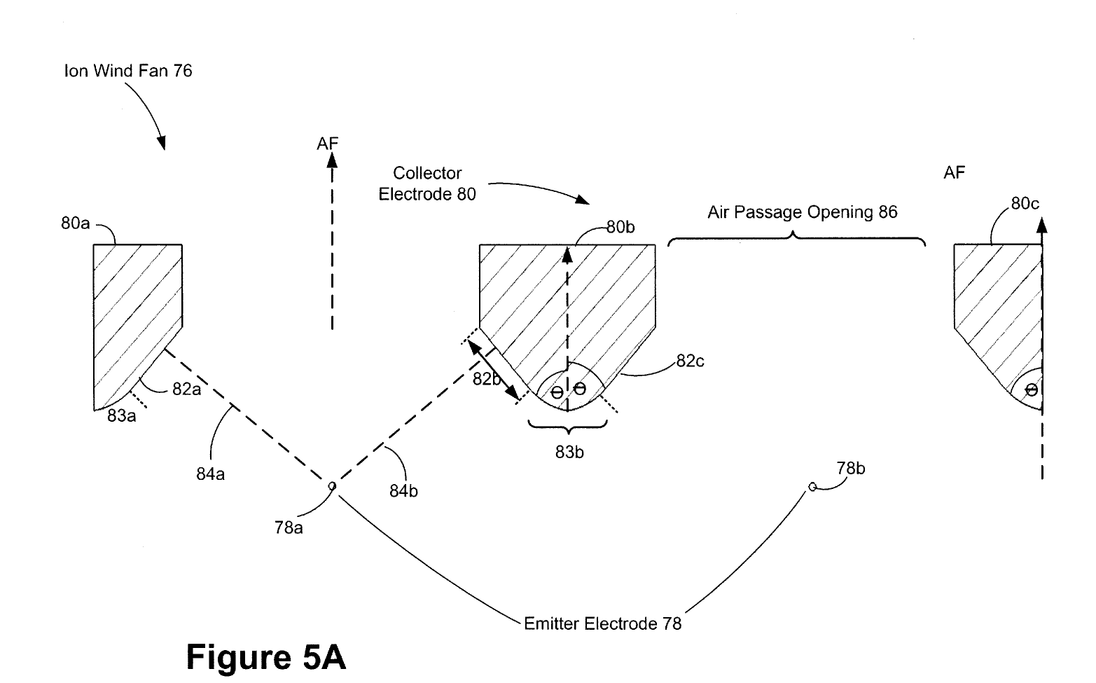

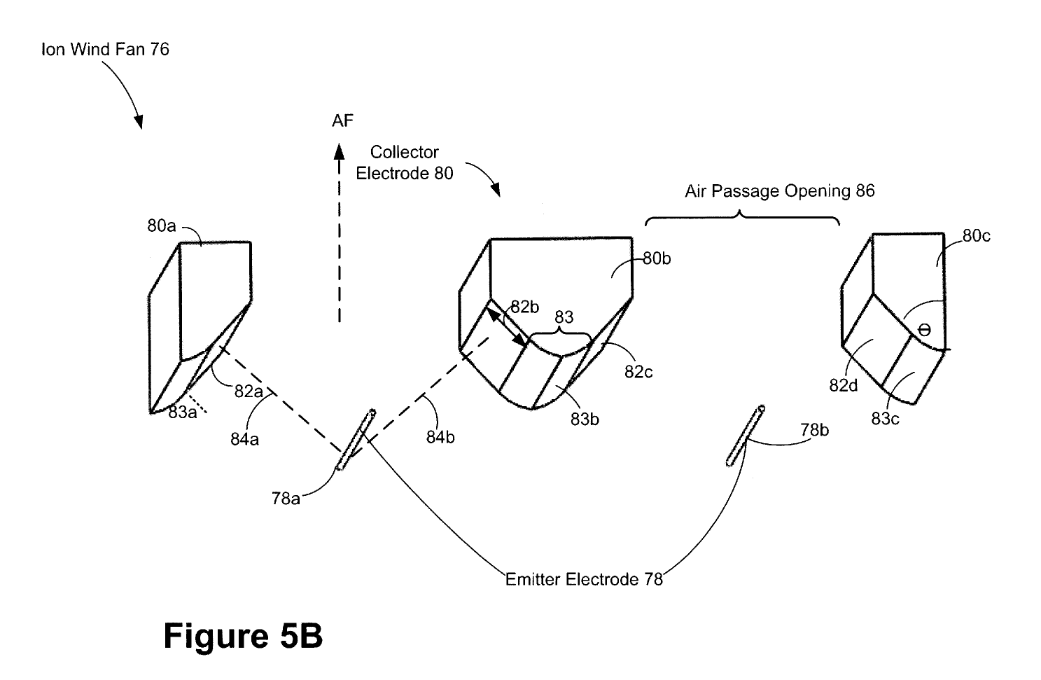

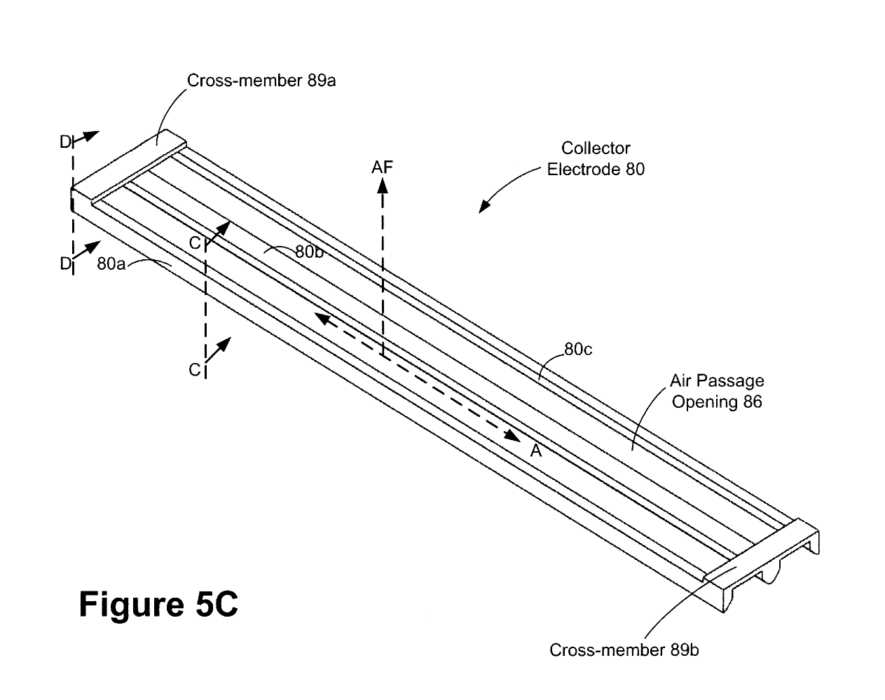

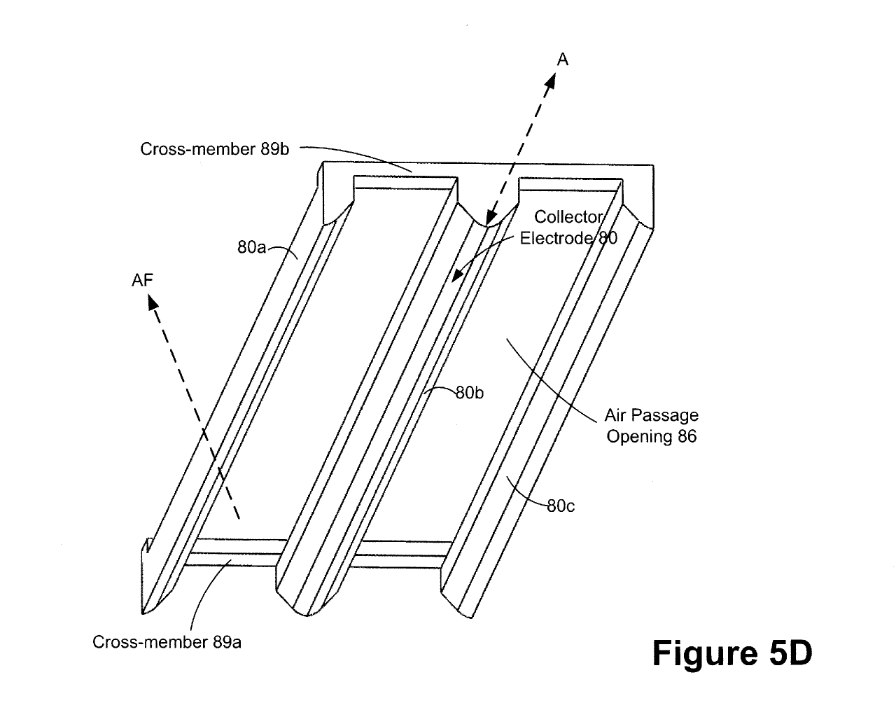

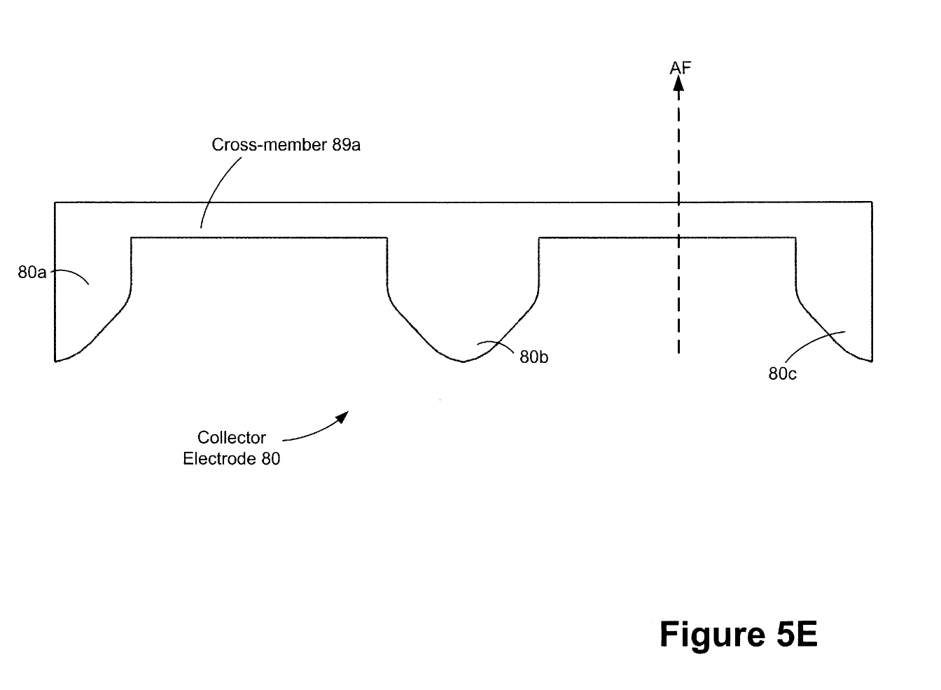

In the embodiments shown in and described with reference to FIGS. 4A-C, the elongated members of the collector electrodes were essentially made of angled and curved sheets of conductive material. These sheets of metal were shown in cross-section, but they are elongated in the longitudinal direction of the ion wind fan. In another embodiment of the present invention that is now described with reference to FIGS. 5A-E, the elongated members are solid bar-like members.

FIG. 5A is a cross-section of an ion wind fan 76 in a direction perpendicular to the longitudinal direction. FIG. 5A is actually a cross-section of the collector electrode 80 shown in FIG. 5C along the line C-C, with the addition of emitter electrodes. Once again, the view sights down in the longitudinal direction.

In this embodiment, the collector electrode 80 is again includes three elongated members (80a-c) that are basically rods elongated in the longitudinal direction having cross sections as shown in FIG. 5A. The ion wind fan 76 also has two emitter electrodes 78 and two air passage openings 86, thus also being a two-channel fan 76. The isolator has been omitted for simplicity and ease of understanding.

The left-side-member 80a has a curved surface portion 83a in the upstream direction, that transitions into a slanted planar surface portion 82a further upstream in the direction of airflow AF. Even further upstream, the slanted planar portion 82a joins at an angle with a parallel planar surface portion that is parallel with the direction of airflow AF. The right-side member 80c is a mirror image of the left-side member 80a reflected around the central airflow axis.

The center member 80b is an elongated solid bar having a upstream surface that is essentially the same as the surface of the center member 71b in FIG. 4C. The upstream surface of the center member 80b includes a left slanted planar surface portion 82b that transitions into a double-radiused rounded tip portion 83b, which again transitions into a right slanted planar surface portion 82c. The angle of slant of the slanted planar portions 82—represented by the angle θ measured from the airflow axis AF in the downstream direction—is approximately 45 degrees in the embodiment shown in FIG. 5A. Other angles can be used for other embodiments, as set forth above.

Furthermore, while the rounded tip portion 83b is double-radiused in this embodiment, a single radius curved surface can be used in another embodiment to create a rounded tip portion similar to surface 64b described with reference to FIG. 4B. The air passage opening 86 is defined by the elongated space between the elongated members 80a-c. A one-channel ion wind fan can be formed by removing the center member 80b and one of the emitter electrodes 78b and centering the remaining emitter electrode 78a between the left- and right-side members 80a, 80c. Similarly, additional channels can be added by the creation of additional air passage openings 86 by adding more center members 80b and emitter electrodes 78.

As can be seen in FIG. 5A, the active surface of the collector electrode 80—the upstream surface or the surface “facing” towards the emitter electrodes 78—is similar to the surface of active surface of the collector electrode 71 shown in FIG. 4C. However, the elongated members 78a-c in FIG. 5A are solid bars instead of curved sheets. In yet another embodiment, the solid bars 80a-c can be made of any material with a conductive coating. For example, the elongated members 80a-c can be made of solid or hollow plastic coated with a metallic coating. In yet other embodiments, the elongated members 80a-c would look the same from the outside, but would be hollow on the inside.

As in other embodiments, the dotted lines 84a and 84b show the closest distance between the left emitter electrode 78a and the left 80a and center 80b members. It can be seen that—once again—the “near point” on the left member 80a is along the slanted planar surface 82a and that the near point of the center member 80b is along the left-side slanted planar surface 82b of the center member 80b.

In the embodiment illustrated in FIG. 5A (and all other illustrated embodiments) the angle of slant (0) is the same for all slanted planar portions 82. However, in other embodiments, not all slanted planar portions 82 need have the same degree of slant from the direction of airflow axis AF.

FIG. 5B is a perspective view of a cross-sectioned portion of the ion wind fan 76 discussed with reference to FIG. 5A. The three-dimensional nature of the elongated members 80a-c is more readily visible in FIG. 5B. The alphanumeric labels are consistent between FIGS. 5A and 5B. The emitter electrodes 78 are visible as wires, and the planar 82 and rounded 83 upstream surfaces are visible in three dimensions. Furthermore, it is more visible—as illustrated by dotted lines 84a and 84b—that all points on the surface of the collector electrode 80 that are nearest the emitter electrodes lie along a line in the slanted planar surfaces 82.

FIG. 5C is a top perspective view of the collector electrode 80 of the ion wind fan 76 being described with reference to FIGS. 5A-E. The isolator and the emitter electrodes 78 are not shown for simplicity and ease of understanding. The collector electrode 80 is viewed from the downstream direction. The longitudinal axis A and the airflow axis AF and direction are shown for clarity.

As can be seen in FIG. 5C, the collector electrode 80 includes the three cross members 80a-c described in detail with reference to FIGS. 5A-B and two cross-members 89a and 89b. Cross-member 89a connects the three elongated members 80a-c—that are substantially parallel to one another—on one end of the collector electrode 80, and cross-member 89b connects the three elongated members 80a-c at the longitudinally opposite end of the collector electrode 80.

In one embodiment, the elongated members 80a-c and the cross-members 89 are made of one integral piece. For example, the entire collector electrode 80 can be machined from one integral piece of metal, or stamped, molded, or injection-molded and coated with a conductive surface layer. In other embodiments, the individual members can be welded or otherwise attached during collector 80 manufacturing.

The line C-C shows the cross-section of the collector electrode 80 that was shown in FIG. 5A. FIG. 5E shows a cross-section taken along the line D-D, which includes a cross-sectional view of the cross member 89a. FIG. 5D is bottom perspective view of the collector electrode 80. While FIG. 5C shown the collector electrode 80 from the upstream side, FIG. 5D shows the upstream side of the collector electrode 80. Once again, the isolator and emitter electrodes 78 are omitted for simplicity and ease of understanding.

As can be seen in FIGS. 5C and 5D, an air passage openings 86—in one embodiment—is defined by the substantially elongated rectangular opening between two elongated members (such as 80b and 80c) and two cross-members (such as 89a and 89b). Thus, the air passage opening 86 can be described as an elongated opening that is elongated in the longitudinal direction having chamfered edges on the upstream side in the longitudinal direction. The angle of chamfer is basically Ø, the same as the degree of slant. The chamfered edges transition into a rounded edge. While in the embodiment shown in FIG. 5D the edges perpendicular to the longitudinal direction are not chamfered, they may be in other embodiments.

The embodiment shown in FIGS. 5C and 5D has one air passage opening per channel/emitter electrode, and cross-members 89 located only at the end portions of the collector 80 that are likely to be inactive portions. However, in other embodiments, additional cross-members may be placed perpendicularly across the elongated members 80 to create additional air passage openings.

As stated above, FIG. 5E is a cross-sectional view of the collector electrode 80 of FIG. 5C along the line D-D. As can be seen, except for the cross-member 89a being visible in cross-section, the collector electrode 80 of FIG. 5E is virtually identical to the same collector electrode 80 shown in FIG. 5A.

The collector electrode discussed with reference to FIGS. 5A-E only had curved and slanted surfaces on the upstream side. The downstream surface is composed of parallel and perpendicular planar surfaces. Since generally only the upstream side of the collector electrode is active in generating ionic wind, shaping of the upstream side is generally of greater importance with regards to the electrostatic properties of an ion wind fan.

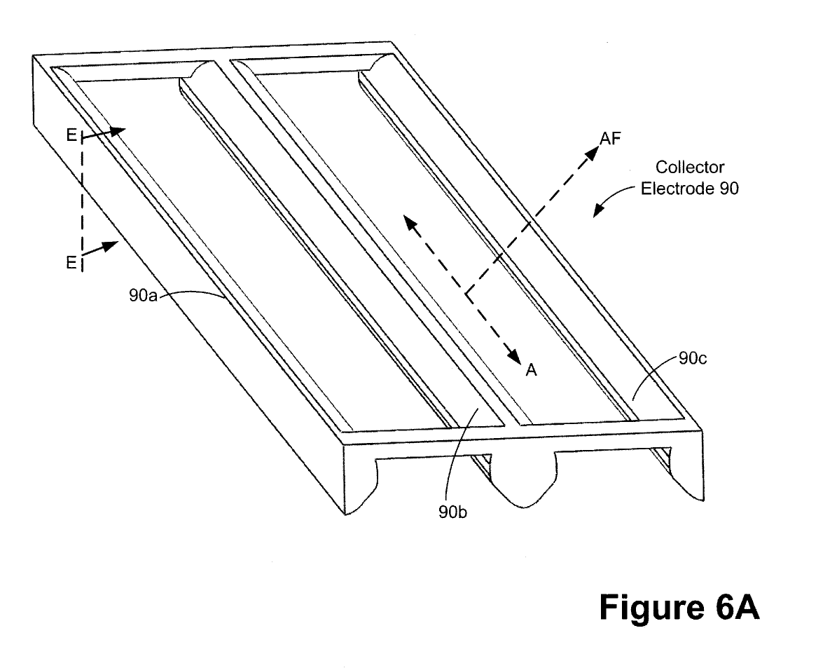

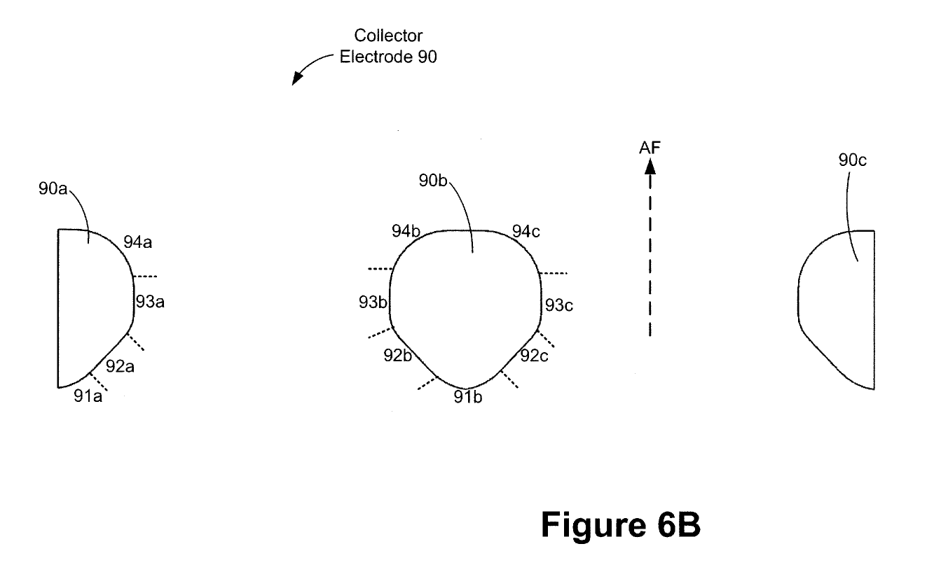

However, the shape of the downstream side of the collector electrode—the side facing away from the emitter electrodes—does factor into the aerodynamics and flow resistance of the collector electrode, and thus, the ion wind fan. Thus, the collector electrode 90 shown in FIGS. 6A and 6B has a curved and aerodynamically shaped downstream side to decrease the airflow resistance of the ion wind fan. FIG. 6A is a perspective view of the collector 90 from the downstream (top) direction, so the curved and aerodynamically shaped downstream side surfaces are visible.

FIG. 6B is a cross-sectional view of the collector electrode 90, the cross-section taken at line E-E in FIG. 6A. The collector electrode has three elongated members 90a-c having slanted planar surfaces 92 and rounded surfaces 91 on the upstream side, as described further above. However, in the embodiment shown in FIG. 6B, the slanted planar surfaces 92 transition smoothly to parallel surface 93 and then to a downstream rounded surface 94. Such rounding and smoothing of the surfaces operates both to reduce the electrical field concentration along the surface of the collector electrode 90 and to reduce the airflow resistance of the collector electrode 90. In other embodiments, other known aerodynamic features—such as teardrop shapes—can be used for the downstream surfaces of the collector electrode.

In the descriptions and Figures above, the emitter electrodes have been represented by wire electrodes. However, other embodiments of the present invention can use different emitter geometries, such as shim emitters, bar emitters, pin emitters, and other such emitter electrodes. Furthermore, pairs of emitter electrodes can be provided together to generate dielectric barrier discharge. The embodiments of the present invention are not limited to any particular type of emitter electrode or discharge phenomena.

Furthermore, while the planar portions and surfaces of the collector electrodes described above have been described as flat and planar, it is understood that the “planar” portions may not form perfect planes, but instead be substantially planar. Both manufacturing tolerances and purposeful design may introduce roughness or curvature to the planar portions, without departing from the spirit of the invention. Thus, in one embodiment the planar surface is considered planar is its arc has a chord length to sagitta (sometimes called “segment height”) ratio of at least 10 to 1. In other embodiments this ration can be required to be 20 to 1, or even higher.

Furthermore, the example ion wind fans described and pictured above are shown as having two emitter electrodes. However, any number of emitter electrodes can be used, including one, to create one or more-channel ion wind fans. While most electronics cooling applications using a wire emitter will have between 1-10 emitter electrodes, the invention is not limited to any range of emitter electrodes used.

Figures such as FIG. 4C and FIG. 5A and the accompanying descriptions describe and show the ion wind fan in cross section with the isolator omitted for simplicity and ease of understanding. However, the perspective views and the general understanding of one skilled in the art will enable them to imagine a three-dimensional collector electrode and ion wind fan based on the simplified cross-sections. Since any type of isolator can be used with embodiments of the present invention, the specific shapes of the possible isolators are not discussed in detail herein.

In the descriptions above, various functional modules are given descriptive names, such as “ion wind fan power supply.” The functionality of these modules can be implemented in software, firmware, hardware, or a combination of the above. None of the specific modules or terms—including “power supply” or “ion wind fan”—imply or describe a physical enclosure or separation of the module or component from other system components.

Furthermore, descriptive names such as “emitter electrode,” “collector electrode,” and “isolator,” are merely descriptive and can be implemented in a variety of ways. For example, the “collector electrode,” can be implemented as one piece of metallic structure (as shown in the FIG. 5C, for example), but it can also be made of multiple members spaced apart, and connected by wires or other electrical connections to the same voltage potential, such as ground.

Similarly, the isolator can be the substantially frame-like component shown in FIG. 2A, but it can have various shapes. The electrodes and the isolator are not limited to any particular material; however, the isolator will generally be made of a dielectric material, such as plastic, ceramic, and other known dielectrics. Thus in one embodiment, any of the collector electrodes discussed herein can be substituted for the collector electrode 32 of FIG. 2A to create an ion wind fan according to an embodiment of the present invention. In other embodiments, other isolator designs can be used, as long as it establishes substantially the same spatial relationships between the electrodes.

What is claimed:

1. An ion wind fan having a longitudinal axis, a first end, and a second end longitudinally opposite to the first end, the ion wind fan comprising:
an emitter electrode oriented in the direction of the longitudinal axis;
a collector electrode having a first member and a second member that are oriented in the direction of the longitudinal axis, the first member comprising a first planar portion and a first rounded portion, and the second member comprises a second planar portion and a second rounded portion; and
an isolator to which the emitter electrode and the collector electrode are attached, wherein the spatial relationship between the emitter electrode and the collector electrode is such that the emitter electrode is nearest to the collector electrode at the first planar portion of the first member and at the second planar portion of the second member along the length of the emitter electrode.

2. The ion wind fan of claim 1, wherein an airflow is generated when a sufficient potential is applied across the emitter electrode and the collector electrode, wherein the airflow has a direction that is substantially perpendicular to the longitudinal direction.

3. The ion wind fan of claim 2, wherein the first planar portion and the second planar portion are not parallel to the direction of the airflow.

4. The ion wind fan of claim 3, wherein the first planar portion and the second planar portion are angled toward each other at a substantially equal angle from the direction of the airflow.

5. The ion wind fan of claim 4, wherein the substantially equal angle comprises and angle between 25 and 75 degrees.

6. The ion wind fan of claim 5, wherein the substantially equal angle comprises approximately 45 degrees.

7. The ion wind fan of claim 1, wherein the first planar portion transitions to the first rounded portion along an upstream edge of the first planar portion and the second planar portion transitions to the second rounded portion along an upstream edge of the second planar portion.

8. The ion wind fan of claim 7, wherein the first member further comprises a third rounded portion, wherein the first planar portion transitions to the third rounded portion along a downstream edge of the first planar portion.

9. The ion wind fan of claim 8, wherein the second member further comprises a fourth rounded portion, wherein the second planar portion transitions to the fourth rounded portion along a downstream edge of the second planar portion.

10. An ion wind fan comprising:
a wire emitter electrode held in tension in a first direction; and
a collector electrode having an elongated opening having an upstream edge and a downstream edge, the elongated opening being elongated in the first direction and positioned downstream of the wire emitter electrode so that the wire emitter electrode is substantially centered along the length of the elongated opening, wherein the downstream edge of the elongated opening comprises a chamfered portion, the chamfered portion having an upstream edge and a downstream edge oriented in the first direction.

11. The ion wind fan of claim 10, wherein the chamfered portion of the downstream edge of the elongated opening is adjacent to a radius portion of the downstream edge of the elongated opening along the downstream edge of the chamfered portion.

12. The ion wind fan of claim 11, wherein the chamfered portion of the downstream edge of the elongated opening is adjacent to a second radius portion along the upstream edge of the chamfered portion, the second radius portion comprising a transition from the downstream edge of the elongated opening to the upstream edge of the elongated opening.

13. The ion wind fan of claim 12, wherein the upstream edge of the elongated opening comprises an aerodynamic feature configured to improve the aerodynamics of the collector electrode.

14. The ion wind fan of claim 11, wherein the collector electrode is nearest to the emitter electrode along the chamfered portion of the downstream edge of the elongated opening.

15. The ion wind fan of claim 14, wherein the chamfered portion of the downstream edge of the elongated opening is chamfered at an angle between 25-75 degrees from a direction of desired airflow.

16. The ion wind fan of claim 15, wherein the chamfered portion of the downstream edge of the elongated opening is chamfered approximately 45 degrees from a direction of desired airflow.

17. A collector electrode for an ion wind fan, the collector electrode having a longitudinal axis, a first end, and a second end longitudinally opposite to the first end, the collector electrode comprising:
a first member oriented in the direction of the longitudinal axis, the first member having a left side and a right side relative to an axis of desired airflow that is substantially perpendicular to the longitudinal axis, the first member comprising a first planar surface on the left side of the first member that is angled away from the axis of desired airflow and a second planar surface on the right side of the first member that is angled away from the axis of desired airflow.

18. The collector electrode of claim 17, wherein the first member further comprises a rounded surface connecting the first planar surface and the second planar surface, the rounded surface forming an edge pointing in the upstream direction.

19. The collector electrode of claim 18, wherein the rounded surface comprises a double-radius rounded surface.

20. The collector electrode of claim 17, wherein first member further comprises a downstream surface, wherein the downstream surface includes at least one aerodynamic feature.
